(19) United States
(12) Patent Application Publication
(10) Pub. No.: US 2026/0026487 A1
(43) Pub. Date: Jan. 29, 2026

(54) Fishing Rod Holder

(71) Applicant: Robert Michael Stoddard, Allen Park, MI (US)

(72) Inventor: Robert Michael Stoddard, Allen Park, MI (US)

(21) Appl. No.: 19/279,533

(22) Filed: Jul. 24, 2025

Related U.S. Application Data
(60) Provisional application No. 63/675,652, filed on Jul. 25, 2024.

(51) Int. Cl. A01K 97/10; A45F 5/00

(52) U.S. Cl. CPC A01K 97/10; A45F 5/00; A45F 2005/008

(57) ABSTRACT

A fishing rod holder designed to strap the users arm and allow a fishing rod to be positioned within the tubular body of the holder. The fishing rod holder comprises a back plate, a plurality of adjustable bands, and plurality of buckles, to allow the holder to be secured to the users arm, by way of the adjustable bands. The tubular body has an angled crown, allowing space for the reel of a rod. The tubular body further comprises an elongated cutout to allow the rod to be inserted far enough into the tubular body to allow the invention to work. The straps are securely fastened around the users arm by way of a hook and loop material.

### FIELD OF THE INVENTION

The present invention relates generally to fishing accessories and wearable devices. More specifically, the present invention discloses a fishing rod holder that can be worn on the user's forearm.

### BACKGROUND OF THE INVENTION

A wide variety of fishing accessories have been made available to make fishing a more enjoyable experience. For example, fishing rod holders have been made available to help the user support the fishing rod without having to grab the fishing rod with one or both hands. Some fishing rods holders are designed to be secured to an external object so that the fishing rod is supported by the external object. For example, some fishing rod holders can be attached to the side of a boat, a rail, etc. Other fishing rod holders have been designed to be worn by the user so that the user's body supports the fishing rod. For example, some fishing rods can be fastened around the user's waist. However, these fishing rod holders can prevent the users from receiving the same physical feedback as they would get by holding the fishing rod with both hands. In addition, the available holders do not provide the same control over the fishing rod as the user would have by directly holding the fishing rod.

Therefore, an objective of the present invention is to provide a fishing rod holder that gives more control over the fishing rod while lessening the load of the fishing rod on the user's body. The present invention can be worn under the forearm so that the fishing rod rests comfortably on the user's arm while enabling the user to control the fishing rod with one or two hands. Another objective of the present invention is to provide a fishing rod holder that can be easily put on without using external fasteners. The present invention can implement one or more compression bands that can be wrapped around the user's forearm to secure the holder to the user's arm. Another objective of the present invention is to provide a fishing rod holder that receives the fishing rod without the use of other tools. The present invention includes a holder tube with a size and shape that securely retains the free terminal end of the fishing rod. The invention includes the ability to adhere (via hook and loop), a therapy pad to the inside of the upper band allowing the user to place the pad into a position of comfort on the tendons to the elbow. Additional features and benefits of the present invention are further discussed in the sections below.

### SUMMARY OF THE INVENTION

The present invention discloses a modified fishing rod holder that mounts under the user's forearm. The present invention is held in place with adjustable elastic bands that can be wrapped around the user's forearm. The adjustable elastic bands are mounted onto the holder tube of the present invention that receives the terminal end of the fishing rod corresponding to the fishing rod butt. The present invention can be worn over clothing if desired and remains out of the way when not in use. Further, the adjustable elastic bands are comfortable and help with pain relief from overuse injuries. The individual adjustable elastic bands can be fastened tighter to provide additional control. For example, the adjustable elastic band closest to the elbow can be wrapped around twice for more tension if desired.

The present invention gives the user more control over the fishing rod. For example, the present invention gives the user the ability to “choke up” on the fishing rod. Sensitivity is enhanced when the user chokes up on the fishing rod to feel the lightest of bites. Further, the present invention assists the user in getting solid hooksets and leverage due the rod butt being secure with the holder tube. The present invention also enables the user to easily remove the fishing rod from the holder tube once a fish has been caught. The present invention can include different sizes and shapes to accommodate different fishing rods. Furthermore, additional features can be implemented to further improve the comfort of the user or the control the user has on the fishing rod while the fishing rod is mounted onto the present invention.

### BRIEF DESCRIPTION OF THE DRAWINGS

FIG. 1 is a top front perspective view of the present invention.

FIG. 2 is a bottom front perspective view of the present invention.

FIG. 3 is a top rear perspective view of the present invention.

FIG. 4 is a bottom rear perspective view of the present invention.

FIG. 5 is a top front perspective view of the present invention, wherein the adjustable bands are shown fastened.

FIG. 6 is a bottom front perspective view of the present invention thereof.

FIG. 7 is a top rear perspective view of the present invention thereof.

FIG. 8 is a bottom rear perspective view of the present invention thereof.

### DETAIL DESCRIPTIONS OF THE INVENTION

All illustrations of the drawings are for the purpose of describing selected versions of the present invention and are not intended to limit the scope of the present invention.

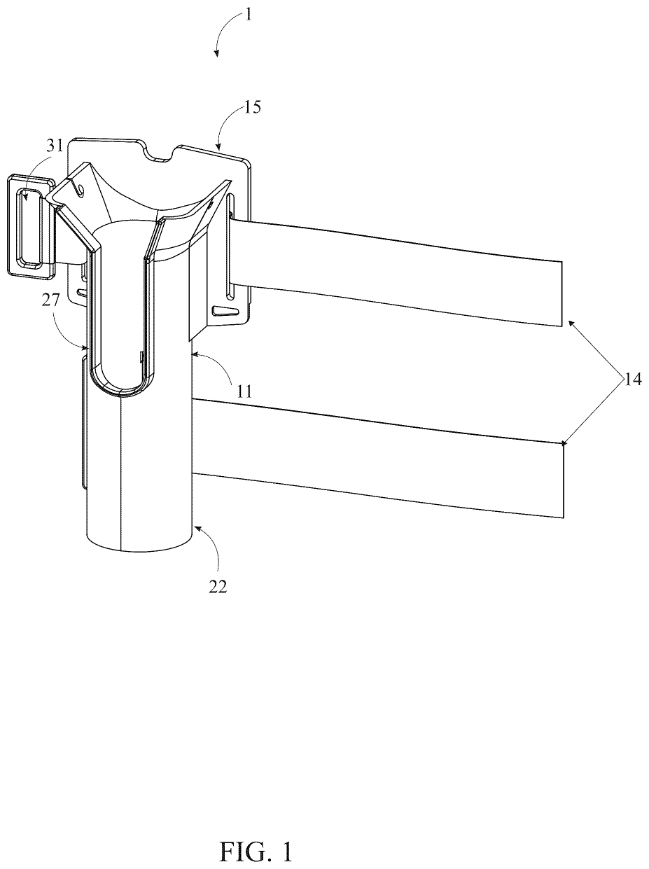

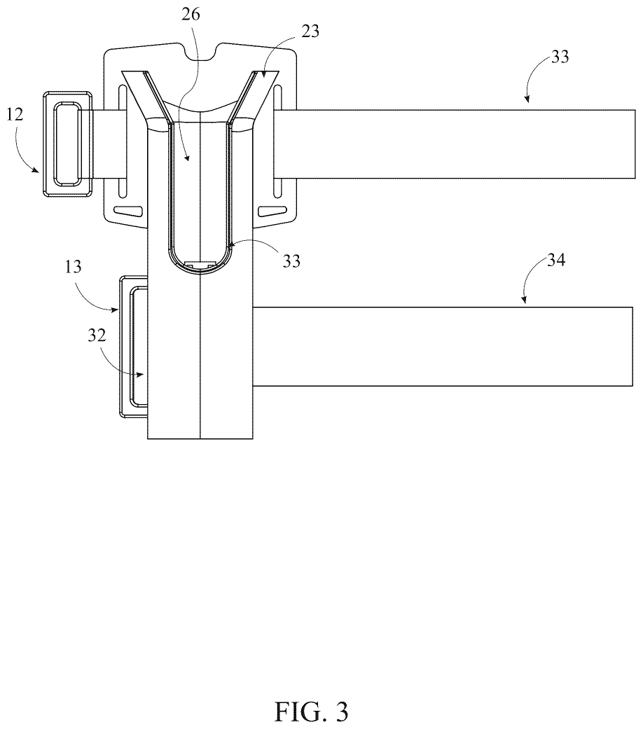

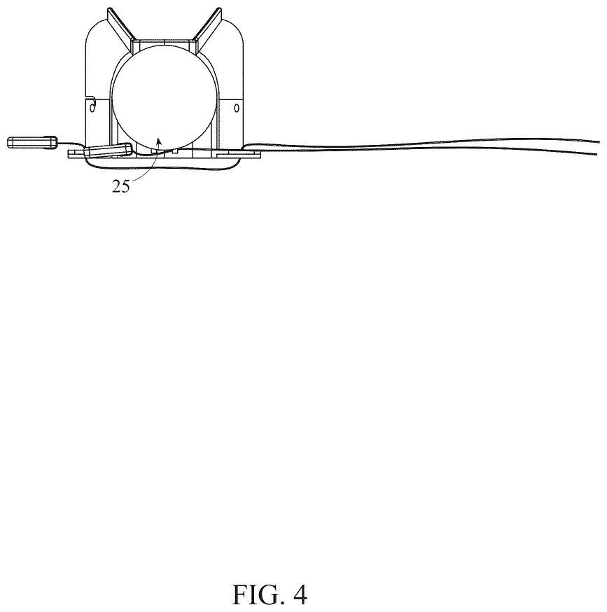

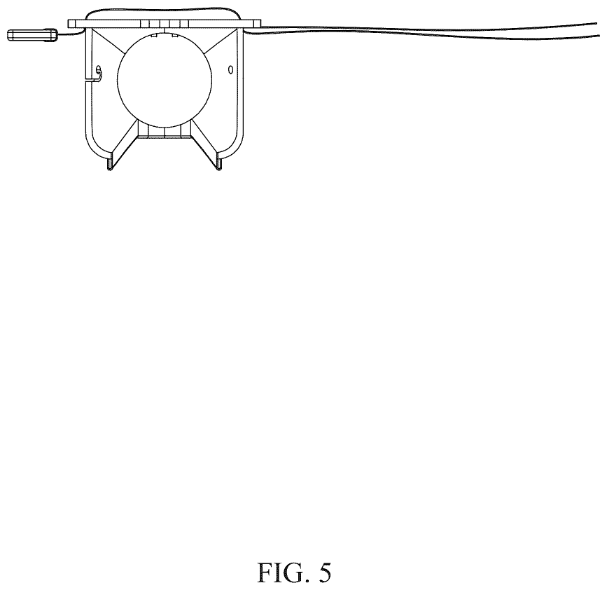

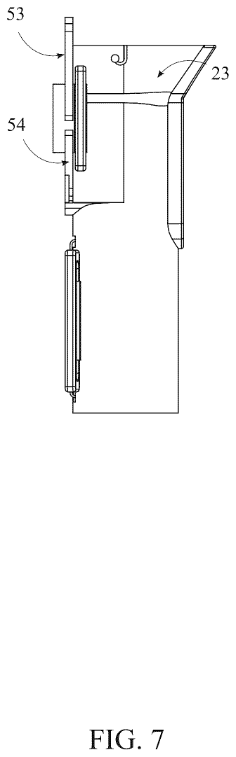

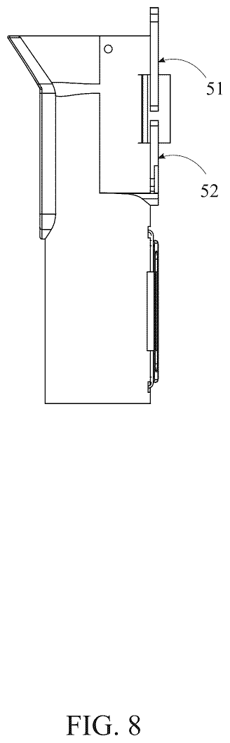

The present invention discloses a fishing rod holder that provides greater comfort and control to the user while fishing. In the preferred embodiment, the present invention comprises a holder tube 11, a proximal buckle 12, a distal buckle 13, a back plate 15, and a plurality of adjustable straps 14. As can be seen in FIG. 1 through 8, the holder tube 11 corresponds to the main structure of the present invention that retains the terminal end of the fishing rod. The proximal buckle 12 and the distal buckle 13 enables the mounting of the plurality of adjustable straps 14 to the holder tube 11. The plurality of adjustable straps 14 enable the removable attachment of the holder tube 11 to the user's forearm or to any other limb if desired.

The general configuration of the aforementioned components enables the user to comfortably hold a fishing rod without limiting the control of the user over the fishing rod. As can be seen in FIG. 1 through 8, the holder tube 11 corresponds to the main structure of the present invention that securely retains a portion of the desired fishing rod. The holder tube 11 is preferably an overall tubular structure with a size large enough to preferably retain the free terminal end of the fishing rod that corresponds to the fishing rod butt. The holder tube 11 can be made from different rigid durable materials including, but not limited to, plastic, metal, etc. The holder tube 11 may comprise a first tubular end 21, a second tubular end 22, and a lateral tubular wall 24. The first tubular end 21 and the second tubular end 22 correspond to the terminal ends of the holder tube 11. The lateral tubular wall 24 corresponds to the lateral structure of the holder tube 11.

As can be seen in FIG. 1 through 8, the holder tube 11 can be arranged as follows: the first tubular end 21 is positioned opposite to the second tubular end 22 along the lateral tubular wall 24. The first tubular end 21 is preferably an open end with a size large enough to enable the fishing rod butt to be inserted into the holder tube 11. In addition, the first tubular end 21 may comprise an angled crown 23, which is a flared in nature to accommodate the different features of the fishing rod. The first tubular end 21 is positioned opposite the second tubular end 22 along the lateral tubular wall 24. The first tubular end 21 has afront side and a rear side. The angled crown 23 is perimetrical to the first tubular end 21. At least one hole may further be integrated adjacent to the first tubular end 21 to receive a carabiner or similar device that allows the present invention to be easily stored away when not in use. Further, the second tubular is perimetrically positioned around a base covering 25, which provides a flat bottom to allow the rod to rest upon when in the fishing rod holder. In alternate embodiments of the present invention, different configurations can be implemented for the holder tube 11 to accommodate different features of the fishing rod. For example, an elongated cutout 26 can be provided adjacent to the first tubular end 21 and oriented parallel to the holder tube 11 to allow features of the fishing rod to protrude out of the holder tube 11. In the present invention the elongated cutout 26 is adjacent to the first tubular end 21. The elongated cutout 26 comprises a lip 27, which traverses the length of the elongated cutout 26. The lip 27 is flat and protrudes outward from the elongated cutout 26 as shown in FIG. 1

As can be seen in FIG. 1 through 8, the at proximal buckle 12 and distal buckle 13 facilitates the attachment of the plurality of adjustable bands to the holder tube 11 so that the user can secure the holder tube 11 to a forearm. The proximal buckle 12 and distal buckle 13 are elongated structures that are slightly longer in height than the plurality of adjustable straps 14. The plurality of adjustable straps 14 comprises a proximal band 33 and distal band 34. The proximal buckle 12 and distal buckle 13 are oriented parallel to the holder tube 11. Further, the plurality of adjustable bands are distributed along the at least one buckle so that the plurality of adjustable bands provide balanced support to the holder tube 11. Furthermore, the proximal band 33 is slidably engaged through back plate 15.

The back plate 15 comprises a left edge and a right edge and further comprises a rear side. A first set of prongs 41 is positioned adjacent to the left edge 43. The back plate 15 is fastened to the rear side of the first tubular end 21. A second set of prongs 42 being positioned adjacent to the right edge 44. The adjacent placement of the first set of prongs 41 and the second set of prongs 42 forms a left channel 55 a right channel 56, which both channels are necessary to allow the proximal band 33 and the distal band 34 to slidably move through the channels to allow for adjustment of the fishing rod holder on the users arm.

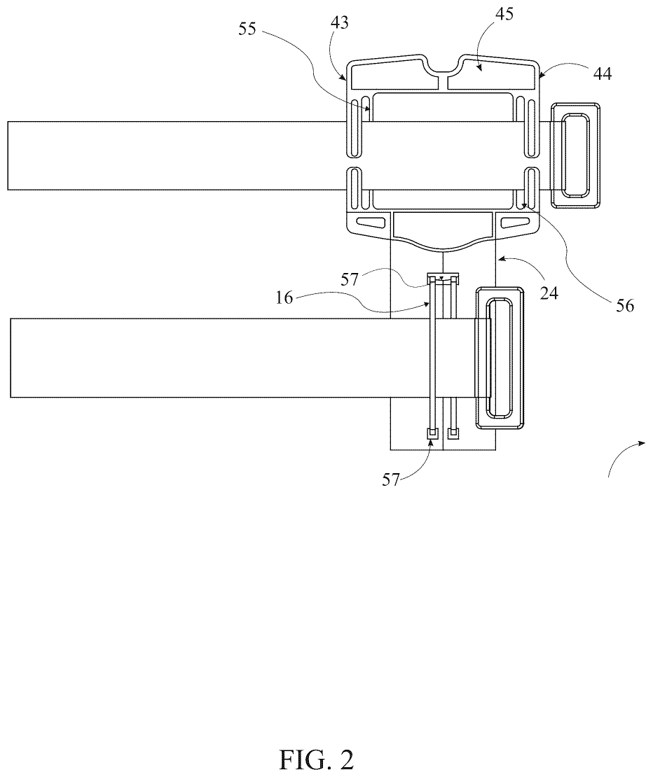

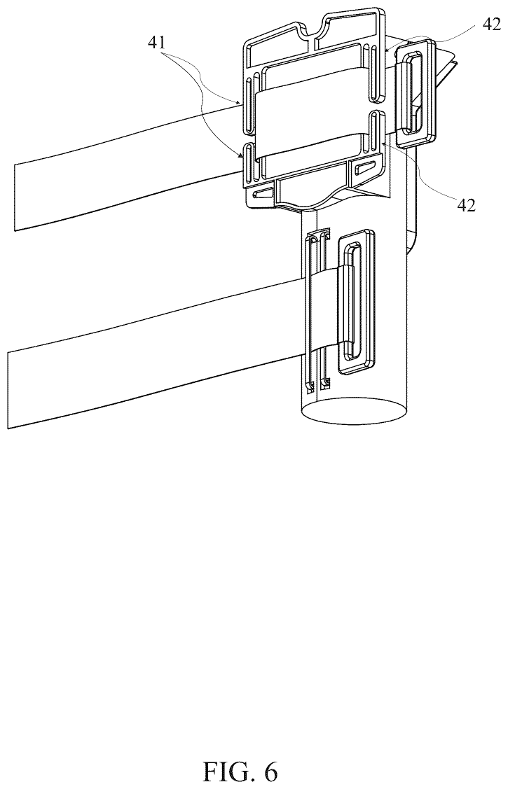

The first set of prongs 41 comprises an upper left prong 51 and a lower left prong 52. The upper left 51 and lower left prong 52 are positioned across from one another, but do not make contact allowing for case in positioning the proximal band 33 within the channel as shown in FIGS. 2 and 6. Similarly, the second set of prongs 42 comprising an upper right 53 prong and a lower right prong 54, which also are positioned across from one another and do not make contact.

As previously discussed, the plurality of adjustable bands enables the fastening of the holder tube 11 to the user's forearms. As can be seen in FIG. 1 through 8, the plurality of adjustable bands includes a proximal band 33 and a distal band 34 and securely fasten the holder tube 11 to the user's forearms. For example, the plurality of adjustable bands comprises a proximal band 33 and a distal band 34. The distal band 34 preferably corresponds to the adjustable band that is fastened adjacent to the user's elbow, while the proximal band 33 corresponds to the adjustable band fastened adjacent to the user's wrist. Further, the distal band 34 is preferably positioned adjacent to the second tubular end 22 so that when the holder tube 11 is positioned on the user's forearm, the second tubular end 22 and the distal band 34 are positioned adjacent to the user's elbow. Furthermore, the proximal band 33 is positioned adjacent to the first tubular end 21 so that when the holder tube 11 is positioned on the user's forearm, the first tubular end 21 and the proximal band 33 are positioned adjacent to the user's wrist. The adjustable bands are held in place by way of a hook and loop material. In other embodiments, different number of adjustable bands can be provided along.

The proximal band 33 is attached to the proximal buckle 12. The proximal buckle 12 comprises a proximal aperture 31, which results in the proximal buckle 12 having a rectangular shape in nature. The proximal aperture 31 is centrally positioned on the proximal buckle 12. Likewise, the distal buckle 13 comprises a centrally positioned distal aperture 32 forming a rectangular buckle in shape. The distal band 34 is attached to the distal buckle 13. The proximal band 33 being traverses through the left channel 55, the rear side 45 of the back plate 15, and through the right channel 56.

The distal band 34 is securely attached to the tubular holder by way of at least one zip tie. A plurality of attachment apertures 57 are positioned on the distal end of the tubular body. The plurality of zip ties 16 traverses through the plurality of attachment apertures 57, holding the distal band 34 in place between the plurality of zip ties 16 and the holder tube 11.

As previously discussed, the plurality of adjustable bands allow the holder tube 11 to be comfortably fastened to the user's forearm. As can be seen in FIG. 1 through 8, each of the plurality of adjustable bands can be adjusted differently around the user's forearm according to the user's preferences. For example, the user may choose to fasten the adjustable band adjacent to the user's elbow tighter than the adjustable band adjacent to the user's writs. To allow the adjustment of each adjustable band, each of the plurality of adjustable bands includes a band body with a first band end, a second band end, and a length-adjusting fastener. The band body corresponds to the main structure of each adjustable band, while the first band end and the second band end correspond to the terminal ends of the band body. So, the first band end is positioned opposite to the second band end along the band body. Further, the length-adjusting fastener enables the first band end to be attached to the second band end along the band body. In other embodiments, different designs can be implemented for the plurality of adjustable bands that match different designs of the holder tube 11.

As can be seen in FIG. 1 through 8, to fasten the desired adjustable band, the band body is wrapped around the corresponding portion of the user's forearm, and the first fastener piece is engaged along the second fastener piece according to the tightness desired. In other embodiments, different fastening mechanisms can be implemented for the plurality of adjustable bands.

Although the invention has been explained in relation to its preferred embodiment, it is to be understood that many other possible modifications and variations can be made without departing from the spirit and scope of the invention.

What is claimed is:

1. A fishing rod holder comprising:
a holder tube;
a backplate;
the holder tube comprising a first tubular end, a second tubular end, an angled crown, and a lateral tubular wall;
the first tubular end is positioned opposite to the second tubular end along the lateral tubular wall;
the angled crown being positioned perimetrical to the first tubular end.

2. The fishing rod holder as in claim 1 comprising:
the second tubular end being perimetrically positioned around a base covering;
the first tubular end having a front side and a rear side; and
the backplate being fastened to the rear side of the first tubular end.

3. The fishing rod holder as in claim 1 comprising:
the backplate comprising a left edge and a right edge; and
the backplate comprising a rear side;
a first set of prongs being positioned adjacent to the left edge.
a second set of prongs being positioned adjacent to the right edge;

4. The fishing rod holder as in claim 3 comprising;
a left channel being formed between the left edge and the first set of prongs; and
a right channel being formed between the right edge and the second set of prongs.

5. The fishing rod holder as in claim 3 comprising:
the first set of prongs comprising an upper left prong and a lower left prong; and
the second set of prongs comprising an upper right prong and a lower right prong.

6. The fishing rod holder as in claim 1 comprising:
an elongated cutout adjacent to the first tubular end; and
the elongated cutout parallel to the holder tube;
a lip traversing the length of the elongated cutout.

7. The fishing rod holder as in claim 1 comprising:
a distal buckle.
the distal buckle comprising a distal aperture; and
the distal aperture being centrally positioned about the distal buckle.

8. The fishing rod holder as in claim 7 comprising:
a distal band; and
the distal band being attached to the distal buckle.

9. The fishing rod holder as in claim 4 comprising:
a proximal buckle;
the proximal buckle comprising a proximal aperture; and
the proximal aperture being centrally positioned on the proximal buckle.

10. The fishing rod holder as in claim 9
a proximal band;
the proximal band being attached to the proximal buckle; and
The proximal band being traversing through the left channel, the rear side of the backplate and through the right channel.

11. A fishing rod holder as in claim 8 comprising:
at least one zip tie;
the tubular holder comprising a plurality of attachment apertures at the distal end of the tubular holder;
the zip tie traversing through the plurality of attachment apertures; and
the distal band being attached to the tubular holder by way of the plurality of zip ties.

12. A fishing rod holder comprising:
a holder tube;
a backplate;
the holder tube comprising a first tubular end, a second tubular end, an angled crown, and a lateral tubular wall;
the first tubular end is positioned opposite to the second tubular end along the lateral tubular wall;
the angled crown being positioned perimetrical to the first tubular end;
the second tubular end being perimetrically positioned around a base covering; and
the first tubular end having a front side and a rear side.

13. The fishing rod holder as in claim 11 comprising:
the backplate being fastened to the rear side of the first tubular end
the backplate comprising a left edge and a right edge;
the backplate comprising a rear side;
a first set of prongs being positioned adjacent to the left edge; and
a second set of prongs being positioned adjacent to the right edge.

14. The fishing rod holder as in claim 13:
a left channel being formed between the left edge and the first set of prongs;
a right channel being formed between the right edge and the second set of prongs;
the first set of prongs comprising an upper left prong and a lower left prong; and
the second set of prongs comprising an upper right prong and a lower right prong.

15. A fishing rod holder as in claim 14 comprising:
a distal buckle;
the distal buckle comprising a distal aperture; and
the distal aperture being centrally positioned about the distal buckle;
a distal band;
the distal band being attached to the distal buckle; and
the distal band being traversing through the left channel, the rear side of the backplate and through the right channel.

16. The fishing rod holder as in claim 15 comprising:
an elongated cutout adjacent to the first tubular end;
the elongated cutout parallel to the holder tube;
a lip traversing the length of the elongated cutout;
at least one zip tie;
the tubular holder comprising a plurality of attachment apertures on the distal end of the tubular holder;
the zip tie traversing through the plurality of attachment apertures; and
the distal band being attached to the tubular holder by way of the plurality of zip ties.

17. The fishing rod holder as in claim 14 comprising:
a proximal buckle;
the proximal buckle comprising a proximal aperture; and
the proximal aperture being centrally positioned on the proximal buckle;
a proximal band;
the proximal band being attached to the proximal buckle; and
the proximal band being traversing through the left channel, the rear side of the backplate and through the right channel.
